(19) United States
(12) Patent Application Publication
(10) Pub. No.: US 2022/0180311 A1
(43) Pub. Date: Jun. 9, 2022

(54) DISPLAY SYSTEM

(71) Applicant: HONDA MOTOR CO., LTD., Tokyo (JP)

(72) Inventors: Toshikatsu Kuramochi, Tokyo (JP); Junya Ono, Tokyo (JP)

(21) Appl. No.: 17/499,896

(22) Filed: Oct. 13, 2021

(30) Foreign Application Priority Data
Dec. 9, 2020 (JP) 2020-204264

(51) Int. Cl. G06Q 10/08; G06F 3/14; G06Q 30/02

(52) U.S. Cl. CPC G06Q 10/0835; G06Q 30/0259; G06F 3/14

(57) ABSTRACT

A display system includes: a portable terminal; a storage part that stores a delivery object; and a display part that is capable of communicating with the portable terminal and displays an advertisement image based on information acquired from the portable terminal. A display surface of the display part is attached to the storage part on an outer portion of the storage part so as to face outward.

### CROSS-REFERENCE TO RELATED APPLICATION

Priority is claimed on Japanese Patent Application No. 2020-204264, filed on Dec. 9, 2020, the contents of which are incorporated herein by reference.

### BACKGROUND

### Field of the Invention

The present invention relates to a display system.

### Background

Techniques that enhance an advertisement effect of a delivery object have been considered. A relevant technique is disclosed in Japanese Unexamined Patent Application, First Publication No. 2002-117114. Japanese Unexamined Patent Application, First Publication No. 2002-117114 discloses a technique in which a home delivery provider carries an advertisement medium requested by an advertiser and delivers the advertisement medium to a customer's home.

### SUMMARY

Techniques are desired in which, when a deliverer who delivers a delivery object such as a home delivery provider moves in a town, it is possible to perform advertising relating to a delivery object stored in a storage part to be delivered by the deliverer.

An object of an aspect of the present invention is to provide a display system capable of performing advertising relating to a delivery object stored in a storage part to be delivered by a deliverer.

A display system according to a first aspect of the present invention includes: a portable terminal; a storage part that stores a delivery object; and a display part that is capable of communicating with the portable terminal and displays an advertisement image based on information acquired from the portable terminal, wherein a display surface of the display part is attached to the storage part on an outer portion of the storage part so as to face outward.

A second aspect of the present invention is the display system according to the first aspect described above, wherein the advertisement image may be an image relating to the delivery object.

A third aspect of the present invention is the display system according to the first or second aspect described above, wherein the advertisement image may be an image relating to a shop that prepares the delivery object.

A fourth aspect of the present invention is the display system according to any one of the first to third aspects described above, wherein the display part may display the advertisement image during delivery of the delivery object.

A fifth aspect of the present invention is the display system according to any one of the first to fourth aspects described above, wherein the display part may display the advertisement image in a case where the display part is within a deliverable area of the delivery object.

A sixth aspect of the present invention is the display system according to any one of the first to fifth aspects described above, wherein the display part may stop displaying of the advertisement image when a distance between the display part and a delivery destination of the delivery object is equal to or less than a predetermined distance.

A seventh aspect of the present invention is the display system according to any one of the first to sixth aspects described above, wherein a state in which the display part displays the advertisement image and a state in which the display part does not display the advertisement image may be switchable by an operation of the portable terminal.

An eighth aspect of the present invention is the display system according to any one of the first to sixth aspects described above, wherein a state in which the display part displays the advertisement image and a state in which the display part does not display the advertisement image may be switchable based on information received from an external device.

A ninth aspect of the present invention is the display system according to the second or third aspect described above, wherein a display time of the advertisement image in the display part may be measured.

A tenth aspect of the present invention is the display system according to the second or third aspect described above, wherein output information relating to the advertisement image displayed on the display part may be output based on acquired position information of the display part.

An eleventh aspect of the present invention is the display system according to the tenth aspect described above, wherein an output form of the output information relating to the advertisement image displayed on the display part may be changed based on the position information.

A twelfth aspect of the present invention is the display system according to the second or third aspect described above, wherein the display part may display code information relating to content that is advertised by the advertisement image.

A thirteenth aspect of the present invention is the display system according to any one of the first to twelfth aspects described above, wherein the storage part may be a bag that stores the delivery object.

A fourteenth aspect of the present invention is the display system according to any one of the first to twelfth aspects described above, wherein the storage part may be attached to a vehicle and store the delivery object.

According to the first to fourteenth aspects, when a deliverer who delivers a delivery object moves in a town, it is possible to perform advertising relating to a delivery object stored in the storage part to be delivered by the deliverer.

### BRIEF DESCRIPTION OF THE DRAWINGS

FIG. 1 is a view showing an example of a delivery management system that includes a display system according to the present embodiment.

FIG. 2 is a hardware configuration view of a management server according to the embodiment.

FIG. 3 is a functional block diagram of the management server according to the embodiment.

FIG. 4 is a functional block diagram of a deliverer terminal and a display device according to the embodiment.

FIG. 5 is a view showing a process flow of a display system according to a first embodiment.

FIG. 6 is a view showing a process flow of a display system according to a second embodiment.

FIG. 7 is a view showing a process flow of a display system according to a third embodiment.

FIG. 8 is a first view showing a process flow of a display system according to a fourth embodiment.

FIG. 9 is a second view showing the process flow of the display system according to the fourth embodiment.

FIG. 10 is a first view showing a process flow of a display system according to a fifth embodiment.

FIG. 11 is a second view showing the process flow of the display system according to the fifth embodiment.

FIG. 12 is a view showing a process flow of a display system according to a sixth embodiment.

FIG. 13 is a view showing a process flow of a display system according to a seventh embodiment.

FIG. 14 is a view showing a process flow of a display system according to an eighth embodiment.

FIG. 15 is a view showing a process flow of a display system according to a ninth embodiment.

FIG. 16 is a view showing a form of a display device according to an eleventh embodiment.

### DESCRIPTION OF EMBODIMENTS

Hereinafter, embodiments of a display system embodiments of the present invention will be described with reference to the drawings.

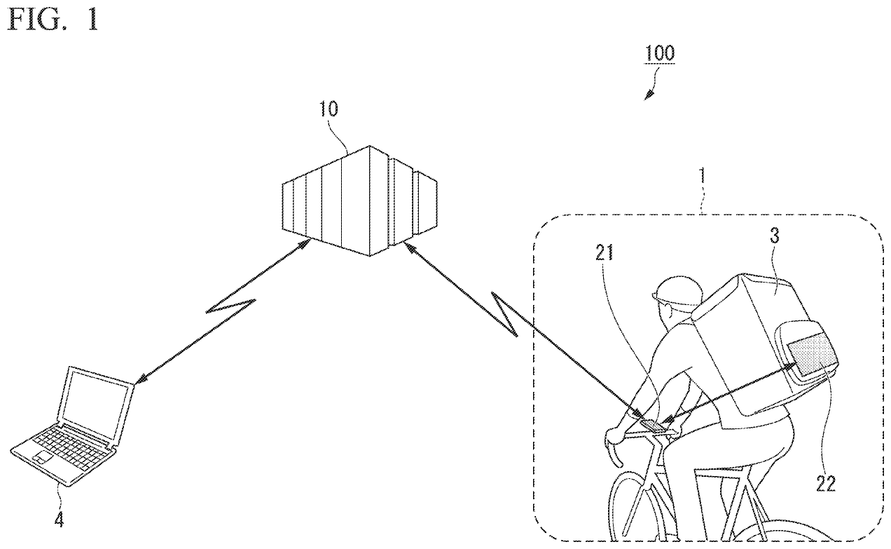

FIG. 1 is a view showing an example of a delivery management system 100 that includes a display system 1 according to the present embodiment.

The display system 1 according to the present embodiment is included in the delivery management system 100. The delivery management system 100 includes a display system 1 and a management server 10. The display system 1 includes at least a deliverer terminal 21 and a display device 22. The deliverer terminal 21 is, for example, a smartphone. The display device 22 is, for example, a tablet terminal.

The management server 10 is a computer (information-processing device) that is provided by a delivery provider of a delivery object for managing delivery of the delivery object. A deliverer of the delivery provider carries the deliverer terminal 21. The deliverer terminal 21 is connected to and communicates with the management server 10 and transmits and receives information for delivery management of the delivery object. The deliverer stores the delivery object in a storage part such as a carry bag 3 and delivers the delivery object on the basis of a command from the management server 10.

A storage tool for attaching the display device 22 to a surface of the carry bag 3 is provided on the carry bag 3. The storage tool is a form of the storage part that stores the delivery object. The storage tool may be, for example, a dedicated case which can contain the display device 22, which is made of a transparent plastic such that a display of the display device 22 can be viewed from the outside, and which stores the display device 22. Alternatively, the storage tool may be a rubber band or the like provided on the carry bag 3 for attachment of the display device 22. When delivering the delivery object, the deliverer uses the storage tool and attaches the display device 22 to the carry bag 3. At this time, the deliverer attaches the display device 22 such that a display of the display device 22 faces outward, on a wall surface (outer portion) of the carry bag such that the display of the display device 22 can be viewed by others. That is, the display system 1 according to the present embodiment includes the deliverer terminal 21 (portable terminal), the carry bag 3 (storage part) that stores the delivery object, and the display device 22 (display part) capable of communicating with the deliverer terminal 21. In the display system 1, the display (display surface) of the display device 22 is attached to the carry bag 3 (storage part) on the outer portion of the carry bag 3 (storage part) so as to face outward such that the display can be viewed by a person who is in the vicinity of the deliverer. At the time of delivery, the deliverer sets the deliverer terminal 21 and the display device 22 to be connected to and communicate with each other by radio communication or the like.

A client terminal 4 is an information-processing device utilized by a user who requests delivery of the delivery object. The management server 10 may be connected to and communicate with the client terminal 4. The management server 10 performs management of the delivery object to be delivered on the basis of a delivery command of a client of the client terminal 4. The management server 10 may perform management of the delivery object to be delivered on the basis of a delivery command from a terminal other than the client terminal 4. The management server 10 performs management for various deliveries on the basis of the delivery command. The information of the delivery command includes, as an example, information of a delivery object to be delivered, a delivery source of the delivery object, an address, a name, and a telephone number of a delivery destination of the delivery object, a delivery request time of the delivery object, and the like.

The management server 10 transmits information relating to the delivery command to the deliverer terminal 21. The management server 10 transmits, to the deliverer terminal 21, advertisement information relating to a delivery object included in the delivery command. The deliverer terminal 21 receives at least the advertisement information and the information of the delivery command. The deliverer terminal 21 displays the information of the delivery command on a display of the deliverer terminal 21. The deliverer terminal 21 transmits the advertisement information to the display device 22. The display device 22 displays an advertisement image included in the advertisement information on a display of a terminal of the display device 22. The display device 22 may output sound information of the advertisement included in the advertisement information from a speaker of the terminal of the display device 22.

The management server 10 is connected to and communicates with the deliverer terminal 21 and the client terminal 4 via a communication line such as a known public wireless network or the Internet.

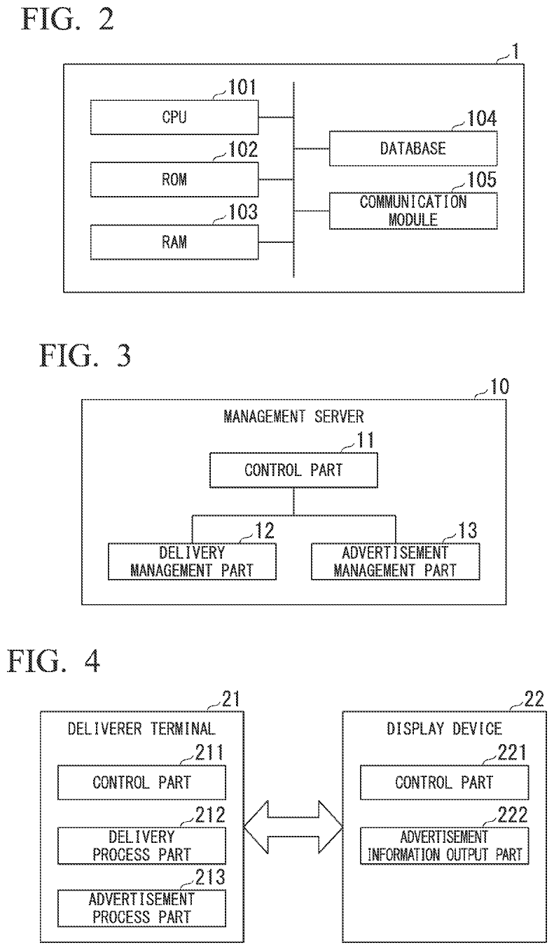

FIG. 2 is a hardware configuration view of the management server 10.

As shown in FIG. 2, the management server 10 is a computer that includes hardware such as a CPU (Central Processing Unit) 101, a ROM (Read-Only Memory) 102, a RAM (Random-Access Memory) 103, a database 104, and a communication module 105. The deliverer terminal 21, the display device 22, and the client terminal 4 are a computer that includes a similar hardware configuration.

FIG. 3 is a functional block diagram of the management server 10.

The management server 10 performs functions of a control part 11, a delivery management part 12, and an advertisement management part 13. Elements of these functions are implemented, for example, by a hardware processor such as a CPU (Central Processing Unit) executing a program (software). Some or all of these configuration elements may be realized by hardware (a circuit part including a circuitry) such as a LSI (Large-Scale Integration), an ASIC (Application-Specific Integrated Circuit), a FPGA (Field-Programmable Gate Array), and a GPU (Graphics-Processing Unit) or may be realized by software and hardware in cooperation. The program may be stored in advance in a storage device (storage device including a non-transitory storage medium) such as a HDD (Hard Disk Drive) or a flash memory or may be stored in a removable storage medium (non-transitory storage medium) such as a DVD or a CD-ROM and be installed by mounting the storage medium on a drive device.

The control part 11 controls other function parts in the management server 10. The control part 11 includes a web server function and transmits a web page to an access source on the basis of accessing from the client terminal 4 or the like.

The delivery management part 12 performs a variety of processes for delivery management of the delivery object on the basis of the delivery command.

The advertisement management part 13 manages displaying in the display device 22 of the advertisement information identified on the basis of the delivery command.

FIG. 4 is a functional block diagram of the deliverer terminal 21 and the display device 22.

The deliverer terminal 21 performs functions of a control part 211, a delivery process part 212, and an advertisement process part 213 by executing a terminal program.

The control part 211 controls other function parts in the deliverer terminal 21.

The delivery process part 212 performs a process of notifying a user of a variety of information relating to delivery or a process for outputting information relating to delivery from the user to the management server 10 on the basis of the command of the delivery management part 12.

The advertisement process part 213 performs a process for outputting the advertisement information to the display device 22 on the basis of the command of the advertisement management part 13.

The display device 22 performs functions of a control part 221 and an advertisement information output part 222 by executing an advertisement output program.

The control part 221 controls other function parts in the display device 22.

The advertisement information output part 222 outputs display information included in the advertisement information to the display or outputs voice information included in the advertisement information to the speaker.

### First Embodiment

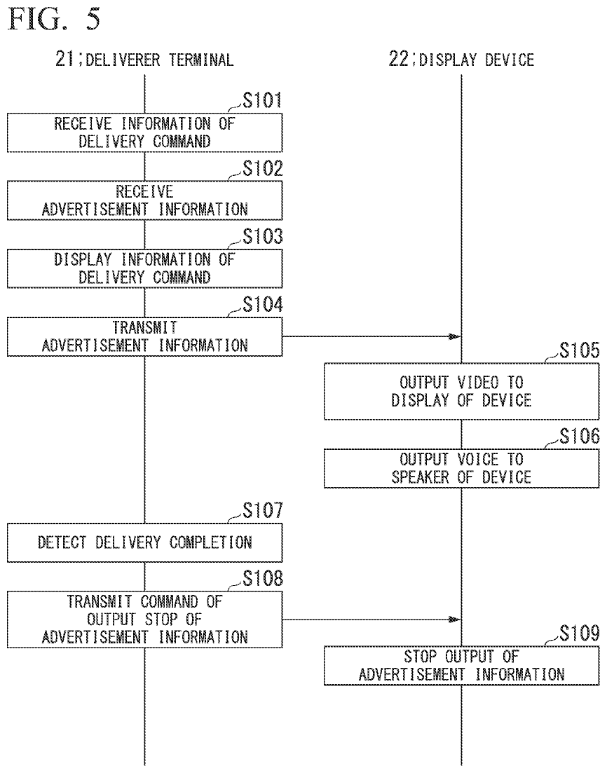

FIG. 5 is a view showing a process flow of a display system 1 according to a first embodiment.

Next, a process flow of the delivery management system 100 and the display system 1 is described.

The delivery management part 12 of the management server 10 acquires a delivery command Information of the delivery command is acquired from the client terminal 4 as an example. The delivery management part 12 may acquire the information of the delivery command from another terminal used by an administrator or the like. The delivery management part 12 identifies a deliverer terminal 21 of a transmission destination of the delivery command on the basis of comparison between a position of the deliverer terminal 21 acquired from the database 104 or the like and a position of a delivery source of a delivery object included in the information of the delivery command. The management server 10 acquires position information (a latitude, a longitude, and the like) of the deliverer terminal 21 at a predetermined interval from the deliverer terminal 21 on the basis of the communication connection with the deliverer terminal 21, and the acquired position information is associated with identification information (a network address or the like) of the deliverer terminal 21 and is stored in the database 104. Further, the position of the delivery source of the delivery object is also associated with identification information (a shop name, an ID, or the like) of the delivery source and is recorded in the database 104 or the like.

In identifying the deliverer terminal 21 of the transmission destination of the delivery command, the delivery management part 12 may identify a deliverer terminal 21 closest to the position of a shop which becomes the delivery source of the delivery object. In identifying the deliverer terminal 21 of the transmission destination of the delivery command, the delivery management part 12 may identify a deliverer terminal 21 located in a predetermined area relative to the position of the shop which becomes the delivery source of the delivery object. The delivery management part 12 may identify one or more deliverer terminals 21 of the transmission destination of the delivery command by way of another method. The delivery management part 12 acquires a network address of the identified deliverer terminal 21 from the database 104 or the like and transmits the delivery command to the network address.

When the deliverer terminal 21 is identified, the delivery management part 12 outputs, to the advertisement management part 13, the information (the identification information of the delivery object or the like) of the delivery object to be delivered included in the delivery command and the network address of the identified deliverer terminal 21. The advertisement management part 13 identifies advertisement information to be delivered on the basis of the information of the delivery object to be delivered. For example, the advertisement management part 13 identifies the advertisement information recorded in association with the identification information of the delivery object in an advertisement table of the database 104. The identification of the advertisement information on the basis of the information of the delivery object by the advertisement management part 13 may be any process. The advertisement information may include video information and voice information. The advertisement management part 13 transmits the identified advertisement information to the network address of the deliverer terminal 21.

The delivery process part 212 of the deliverer terminal 21 receives the information of the delivery command (Step S101). The advertisement process part 213 of the deliverer terminal 21 also receives the advertisement information (Step S102). The delivery process part 212 displays the information of the delivery command on the display of the deliverer terminal 21 (Step S103). The deliverer confirms the information of the displayed delivery command and moves to the shop of the delivery origin. The deliverer receives the delivery object to be delivered at the shop of the delivery origin. The deliverer stores the delivery object in the carry bag 3. The deliverer delivers the delivery object to the address of the delivery destination included in the delivery command.

In this process, the advertisement process part 213 of the deliverer terminal 21 transmits the received advertisement information to the display device 22 that is communicatively connected (Step S104). The advertisement information output part 222 of the display device 22 acquires the advertisement information. When the advertisement information includes video, the advertisement information output part 222 outputs the video to a display of the display device 22 (Step S105). The display displays the video. When the advertisement information includes voice, the advertisement information output part 222 outputs the voice to a speaker of the display device 22. The speaker outputs the voice (Step S106).

The advertisement process part 213 of the deliverer terminal 21 detects delivery completion on the basis of an operation of the deliverer (Step S107). When the delivery completion is detected, the advertisement process part 213 transmits a command of an output stop of the advertisement information to the display device 22 (Step S108). When the command of the output stop is acquired, the advertisement information output part 222 of the display device 22 stops the output of the advertisement information (Step S109). The advertisement process part 213 may perform the command of the output stop of the advertisement information by way of another process. For example, whether a predetermined period of time has elapsed from a delivery request time of the delivery object included in the delivery command may be determined, and the command of the output stop of the advertisement information to the display device 22 may be performed when the predetermined period of time has elapsed.

Here, the contents of the advertisement information may be contents relating to the delivery object to be delivered. For example, when the delivery object is a dish, the contents of the advertisement information may be the name of the dish, a photograph of the dish, reputation of the dish, taste of the dish, video or sound of the dish being cooked, video of a person eating the dish, a recipe for the dish, and the like. Further, the contents of the advertisement information may be contents relating to a shop that has prepared the dish which is the delivery object. For example, the contents of the advertisement information may be a shop name, a telephone number, an address, and a map of a shop where the dish has been cooked, a photograph of the shop, video of the shop, and the like. When the contents relating to the delivery object are displayed, it is possible to inform a passerby near the deliverer or the like of the contents of the delivery object. Further, when the contents relating to the delivery source of the delivery object are displayed, it is possible to inform a passerby of the presence of such a shop within a movement area of a vehicle (a bicycle or the like) on which the deliverer rides, and the shop is advertised.

Processes similar to any one or a plurality of processes performed in the deliverer terminal 21 among the processes of Step S101 to Step S109 in the first embodiment may be performed by the display device 22.

### Second Embodiment

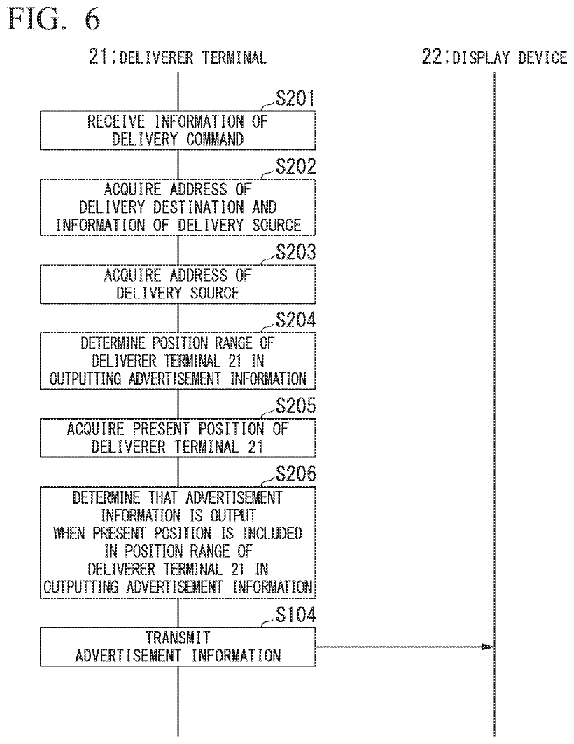

FIG. 6 is a view showing a process flow of a display system 1 according to a second embodiment.

The display device 22 may display the advertisement information only during delivery of the delivery object.

At this time, the advertisement process part 213 of the deliverer terminal 21 acquires the information of the delivery command from the delivery process part 212 (Step S201). The advertisement process part 213 acquires the address of the delivery destination of the delivery object and the information of the delivery source from the information of the delivery command (Step S202). The advertisement process part 213 acquires the address of the shop of the delivery source on the basis of the information of the delivery source (Step S203). The address of the shop of the delivery origin may be acquired by querying the management server 10 by the advertisement process part 213 or may be included in the information of the delivery command in advance. The advertisement process part 213 acquires the latitude and longitude corresponding to the address of the delivery destination of the delivery object and the latitude and longitude corresponding to the address of the shop of the delivery source and determines a position range of the deliverer terminal 21 in outputting the advertisement information on the basis of these latitudes and longitudes (Step S204).

For example, the advertisement process part 213 may use the latitude and longitude corresponding to the address of the delivery destination as an end point, use the latitude and longitude corresponding to the address of the shop of the delivery source as a start point, and determine that a position range having a rectangular shape that includes at least the start point and the end point in the range is the position range of the deliverer terminal 21 in outputting the advertisement information. Alternatively, the advertisement process part 213 may determine that a range of a predetermined circle which includes the start point and the end point and of which the center is a midpoint of a line connecting the start point and the end point is the position range of the deliverer terminal 21 in outputting the advertisement information. Alternatively, the advertisement process part 213 may calculate one or more routes of a road connecting the start point and the end point and determine that a range of the position of the road is the position range of the deliverer terminal 21 in outputting the advertisement information. The determination of the position range of the deliverer terminal 21 in outputting the advertisement information may be any process.

The advertisement process part 213 acquires the present position of the deliverer terminal 21 from a position sensor (a GNSS sensor or the like) included in the deliverer terminal 21 (Step S205). The advertisement process part 213 determines that the advertisement information is output when the present position is included in the position range of the deliverer terminal 21 in outputting the advertisement information (Step S206). The advertisement process part 213 transmits the advertisement information to the display device 22 when it is determined that the advertisement information is output. The advertisement information output part 222 of the display device 22 acquires the advertisement information. When the advertisement information includes video, the advertisement information output part 222 outputs the video to the display of the display device 22. The display displays the video. When the advertisement information includes voice, the advertisement information output part 222 outputs the voice to the speaker of the display device 22. The speaker outputs the voice.

According to the process described above, during delivery of the delivery object, the advertisement information of the shop of the delivery source and the delivery object can be output by the display device 22. Since during delivery of the delivery object, the advertisement information of the shop of the delivery source and the delivery object can be confirmed by a person who is in the vicinity of the deliverer, it is possible to enhance the effect of the advertisement of the shop and the delivery object with respect to a person in an area where the delivery object can be delivered. Further, since the person who is in the vicinity of the deliverer can know the content of the delivery object during delivery, it is possible to entertain the person, and it is possible to help to improve the name recognition and the favorability rating of the delivery provider.

Processes similar to any one or a plurality of processes among the processes of Step S201 to Step S206 in the second embodiment may be performed by the display device 22.

### Third Embodiment

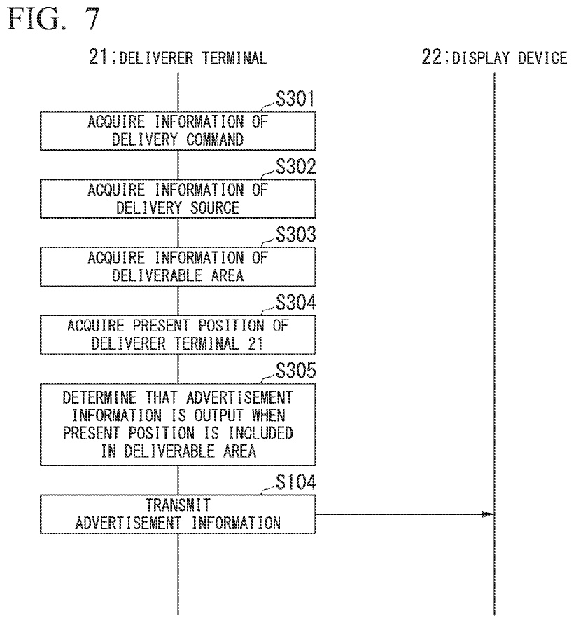

FIG. 7 is a view showing a process flow of a display system 1 according to a third embodiment.

The display device 22 may display the advertisement information only within a deliverable area of the delivery object.

At this time, the advertisement process part 213 of the deliverer terminal 21 acquires the information of the delivery command from the delivery process part 212 (Step S301). The advertisement process part 213 acquires the information of the delivery source of the delivery object from the information of the delivery command (Step S302). The advertisement process part 213 acquires the information of the deliverable area in which the delivery source deals with the delivery of the delivery object on the basis of the information of the delivery source of the delivery object (Step S303). For example, the information of the deliverable area may be acquired by querying the management server 10 by the advertisement process part 213 or may be included in the information of the delivery command in advance. The information of the deliverable area indicates information of the latitude and longitude of a range indicated by the area.

The advertisement process part 213 acquires the present position of the deliverer terminal 21 from a position sensor (a GNSS sensor or the like) included in the deliverer terminal 21 (Step S304). The advertisement process part 213 compares the present position with the latitude and longitude indicated by the deliverable area and determines that the advertisement information is output when the present position is included in the deliverable area (Step S305). The advertisement process part 213 transmits the advertisement information to the display device 22 when it is determined that the advertisement information is output. The advertisement information output part 222 of the display device 22 acquires the advertisement information. When the advertisement information includes video, the advertisement information output part 222 outputs the video to the display of the display device 22. The display displays the video. When the advertisement information includes voice, the advertisement information output part 222 outputs the voice to the speaker of the display device 22. The speaker outputs the voice.

According to this embodiment, when the deliverer carries the deliverer terminal 21 and is located in the deliverable area, it is possible to continuously output the advertisement information. Thereby, a person who has confirmed the advertisement can confirm that the delivery object (a dish or the like) that is output by the display device 22 can be delivered since the advertisement is seen at this place, and therefore, the person who sees the advertisement is motivated to order the delivery object such as the dish.

Processes similar to any one or a plurality of processes among the processes of Step S301 to Step S305 in the third embodiment may be performed by the display device 22.

### Fourth Embodiment

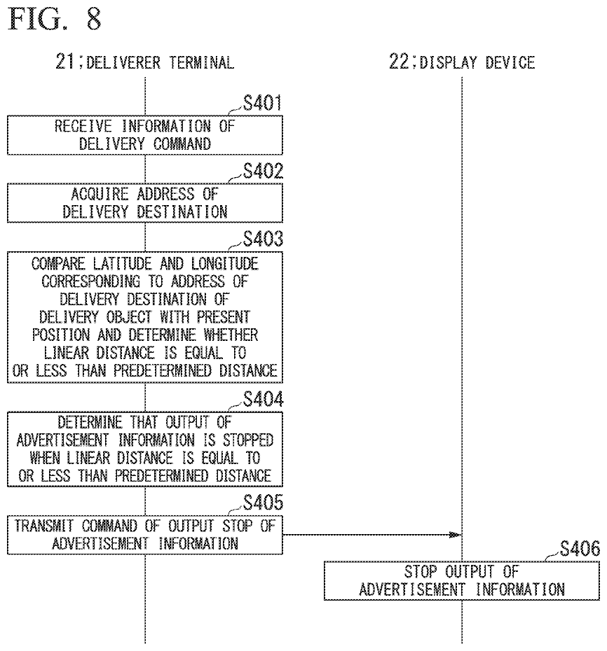

FIG. 8 is a first view showing a process flow of a display system 1 according to a fourth embodiment.

The display device 22 may stop displaying of the advertisement information at a predetermined distance to the delivery destination of the delivery object.

At this time, the advertisement process part 213 of the deliverer terminal 21 acquires the information of the delivery command from the delivery process part 212 (Step S401). The advertisement process part 213 acquires the address of the delivery destination of the delivery object from the information of the delivery command (Step S402). The advertisement process part 213 compares the latitude and longitude corresponding to the address of the delivery destination of the delivery object with the present position and determines whether a linear distance is equal to or less than a predetermined distance (Step S403). The advertisement process part 213 compares the latitude and longitude corresponding to the address of the delivery destination of the delivery object with the present position and determines that the output of the advertisement information is stopped when the linear distance is equal to or less than the predetermined distance (Step S404). When it is determined that the output of the advertisement information is stopped, the advertisement process part 213 transmits a command of an output stop of the advertisement information to the display device 22 (Step S405). When the command of the output stop is acquired, the advertisement information output part 222 of the display device 22 stops the output of the advertisement information (Step S406).

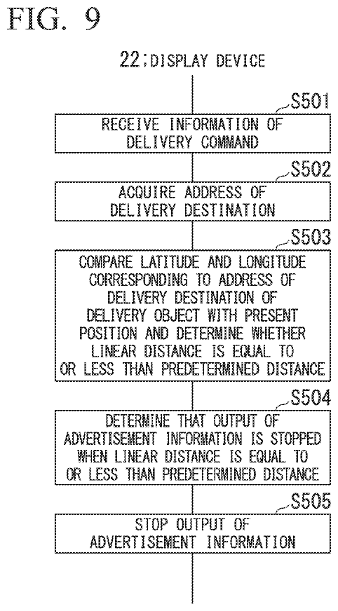

FIG. 9 is a second view showing the process flow of the display system 1 according to the fourth embodiment.

The output stop of the advertisement information may be determined by the display device 22. At this time, similarly, the advertisement information output part 222 of the display device 22 acquires the information of the delivery command from the delivery process part 212 (Step S501). The advertisement information output part 222 acquires the address of the delivery destination of the delivery object from the information of the delivery command (Step S502). The advertisement information output part 222 compares the latitude and longitude corresponding to the address of the delivery destination of the delivery object with the present position and determines whether a linear distance is equal to or less than a predetermined distance (Step S503). The advertisement information output part 222 compares the latitude and longitude corresponding to the address of the delivery destination of the delivery object with the present position and determines that the output of the advertisement information is stopped when the linear distance is equal to or less than the predetermined distance (Step S504). When it is determined that the output of the advertisement information is stopped, the advertisement information output part 222 stops the output of the advertisement information (Step S505).

According to such a process, since the output of the advertisement information is stopped when the position of the deliverer arrives at the vicinity of a client who requests delivery of the delivery object, it is possible to protect private information about what delivery object has been requested to be delivered by the client from being disclosed to a person living in the neighborhood of the client or the like.

### Fifth Embodiment

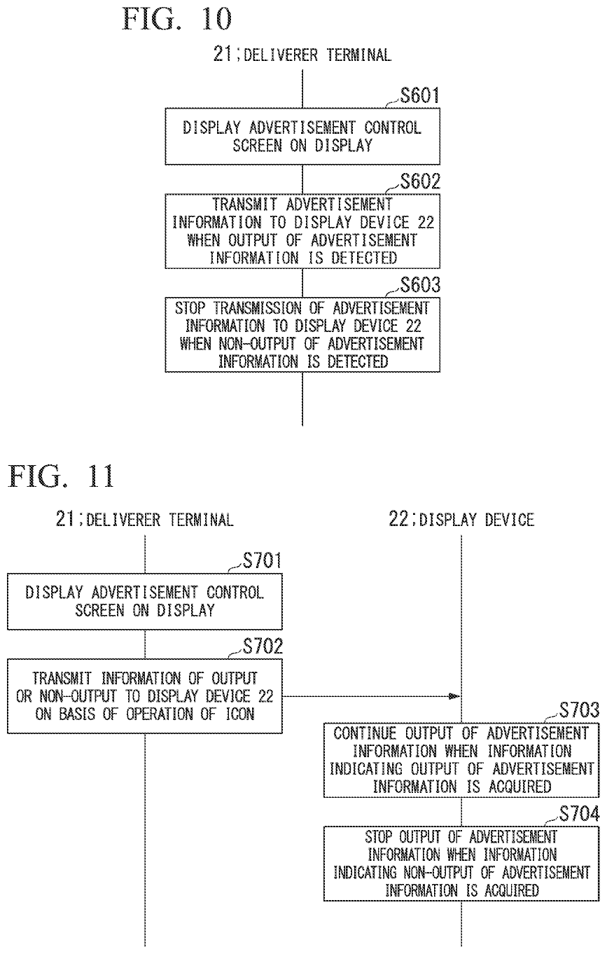

FIG. 10 is a first view showing a process flow of a display system 1 according to a fifth embodiment.

The display device 22 may switch between an output (display) and a non-output (non-display) of the advertisement information by an operation of the deliverer. For example, the advertisement process part 213 of the deliverer terminal 21 displays an advertisement control screen on the display (Step S601). In the advertisement control screen, an icon of a button that switches between the output and the non-output of the advertisement information is displayed. The deliverer presses the icon and switches between the output and the non-output. The advertisement process part 213 transmits the advertisement information to the display device 22 when the output of the advertisement information is detected on the basis of the operation of the icon (Step S602). The advertisement process part 213 stops the transmission of the advertisement information to the display device 22 when the non-output is detected on the basis of the operation of the icon (Step S603). Thereby, the deliverer can switch the output in the display device 22 of the advertisement information.

Processes similar to any one or a plurality of processes among the processes of Step S601 to Step S603 described above may be performed by the display device 22.

FIG. 11 is a second view showing the process flow of the display system 1 according to the fifth embodiment.

The advertisement process part 213 may transmit the information of output or non-output to the display device 22 on the basis of the operation of the icon. For example, the advertisement process part 213 of the deliverer terminal 21 displays an advertisement control screen on the display (Step S701). In the advertisement control screen, an icon of a button that switches between the output and the non-output of the advertisement information is displayed. The deliverer presses the icon and switches between the output and the non-output. The advertisement process part 213 transmits, to the display device 22, the information of output or non-output on the basis of the operation of the icon (Step S702). The display device 22 continues the output of the advertisement information when the information indicating the output of the advertisement information is acquired (Step S703). The advertisement information output part 222 of the display device 22 stops the output of the advertisement information when the information indicating the non-output of the advertisement information is acquired (Step S704).

Processes similar to the processes of Step S701 and Step S702 may be performed by the display device 22.

### Sixth Embodiment

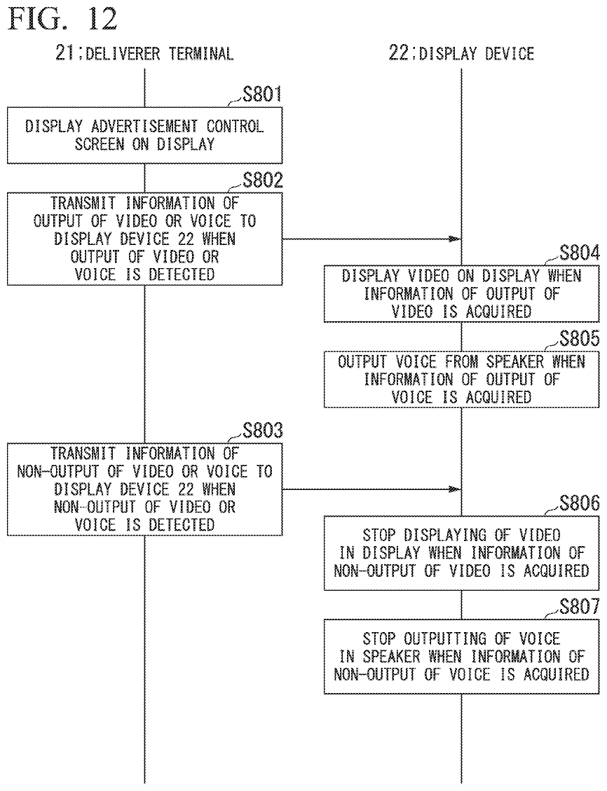

FIG. 12 is a view showing a process flow of a display system 1 according to a sixth embodiment.

The advertisement process part 213 of the deliverer terminal 21 displays an advertisement control screen on the display (Step S801). In the advertisement control screen, an icon of a button that switches between the output and the non-output of video, and an icon of a button that switches between the output and the non-output of voice may be displayed. The deliverer presses the icon of video or voice and switches between the output and the non-output of video or voice. The advertisement process part 213 transmits, to the display device 22, the information of output of video or voice when the output of video or voice is detected on the basis of the operation of the icon of video or voice (Step 802). The advertisement process part 213 transmits, to the display device 22, the information of non-output of video or voice when the non-output of video or voice is detected on the basis of the operation of the icon of video or voice (Step 803). The advertisement information output part 222 of the display device 22 displays the video on the display when the information of output of video is acquired (Step S804). The advertisement information output part 222 of the display device 22 outputs the voice from the speaker when the information of output of voice is acquired (Step S805). The advertisement information output part 222 of the display device 22 stops displaying of the video in the display when the information of non-output of video is acquired (Step S806). The advertisement information output part 222 of the display device 22 stops outputting of the voice in the speaker when the information of non-output of voice is acquired (Step S807). According to such a process, the deliverer can switch between the output and the non-output of video and voice. Processes similar to the processes of Step S801 to Step S803 may be performed by the display device 22.

### Seventh Embodiment

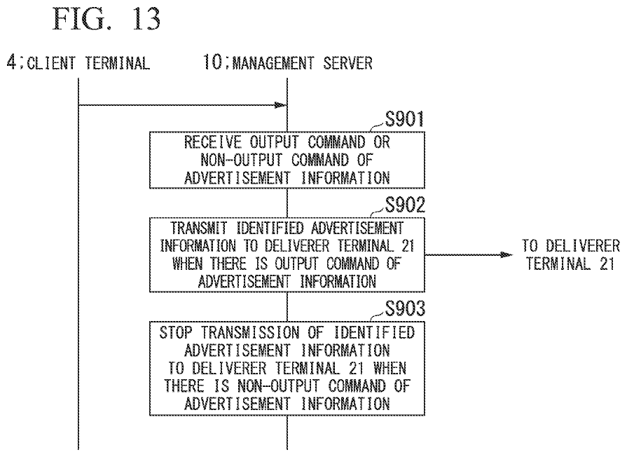

FIG. 13 is a view showing a process flow of a display system 1 according to a seventh embodiment.

The display device 22 may switch between an output (display) and a non-output (non-display) of the advertisement information on the basis of information received from an external device of the display system 1. For example, the output or non-output of the advertisement information may be commanded by a user who requests delivery of the delivery object using the client terminal 4. At this time, the management server 10 receives an output command or a non-output command of the advertisement information from the client terminal 4 (Step S901). The advertisement management part 13 of the management server 10 transmits the advertisement information identified in the process described in the other embodiments described above to the deliverer terminal 21 when there is an output command of the advertisement information (Step S902). The advertisement management part 13 of the management server 10 stops the transmission of the advertisement information identified in the process described in the other embodiments described above to the deliverer terminal 21 when there is a non-output command of the advertisement information (Step S903).

Thereby, in the display system 1, the display device 22 can switch between the output and non-output of the advertisement information in response to the command of the user who uses the external device. Processes similar to the processes of Step S901 to Step S903 may be performed by the display device 22.

### Eighth Embodiment

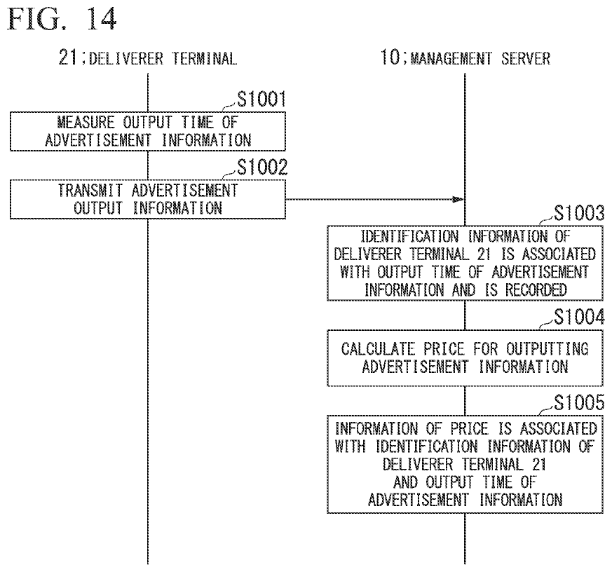

FIG. 14 is a view showing a process flow of a display system 1 according to an eighth embodiment.

An output time of the advertisement information that is output by the display device 22 of the display system 1 may be measured. The output time may be an output (display) time of video or may be an output time of voice. In this process, a time from when the advertisement process part 213 of the deliverer terminal 21 transmits the advertisement information to the display device 22 until it is determined that the output of the advertisement information is stopped on the basis of the user operation or the position information is measured, and the measured time is the output time of the advertisement information (Step S1001). In the process of measuring the output time, the advertisement information output part 222 of the display device 22 may measure the output time and transmit the output time to the deliverer terminal 21. The advertisement process part 213 transmits, to the management server 10, advertisement output information that includes at least the output time of the advertisement information and the identification information of the deliverer terminal 21 (Step S1002). The identification information of the deliverer terminal 21 included in the advertisement output information and the output time of the advertisement information are associated with an advertisement output management table of the database 104 and are recorded by the advertisement management part 13 of the management server 10 (Step S1003). Then, the advertisement management part 13 calculates a price for outputting the advertisement information by multiplying the output time included in the advertisement output information by a unit price (Step S1004). The information of the price may be associated with the identification information of the deliverer terminal 21 and the output time of the advertisement information and may be recorded in the advertisement output management table by the advertisement management part 13 (Step S1005). The price may be an advertisement fee charged to a shop of the delivery origin of the delivery object or the like for outputting the advertisement information. Alternatively, the price may be a fee as a rebate that is paid to a deliverer who outputs the advertisement information and has contributed to the advertisement of the shop of the delivery origin or the like. According to such a process, the display system 1 can calculate the price for the output time of the advertisement information. Processes similar to the processes of Step S1001 and Step S1002 may be performed by the display device 22.

### Ninth Embodiment

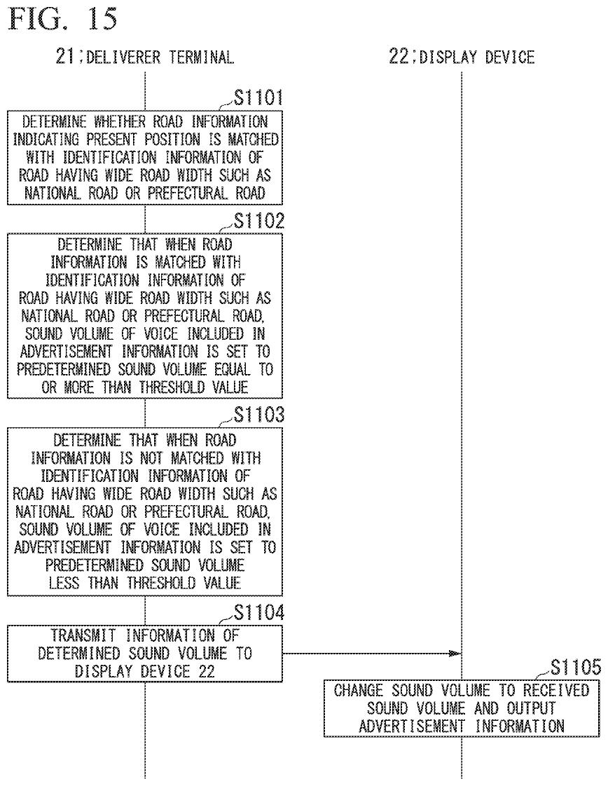

FIG. 15 is a view showing a process flow of a display system 1 according to a ninth embodiment.

The third embodiment and the fourth embodiment described above are examples of an aspect in which the display system 1 outputs the output information (advertisement information) relating to the contents displayed by the display device 22 on the basis of the acquired position information. In addition to such a process, as an example of an aspect in which the output information (advertisement information) is output on the basis of similar position information, the display system 1 may change the output mode of the output information (advertisement information) relating to the contents displayed by the display device 22 on the basis of the acquired position information. Specifically, the advertisement process part 213 acquires the information of the delivery command from the delivery process part 212, then compares the present position with the map information, and determines whether road information indicating the present position corresponds to the identification information of a road having a wide road width such as a national road or a prefectural road (Step S1101). The advertisement process part 213 determines that when the road information indicating the present position is matched with the identification information of a road having a wide road width such as a national road or a prefectural road, the sound volume of the voice included in the advertisement information is set to a predetermined sound volume equal to or more than a threshold value (Step S1102). The advertisement process part 213 determines that when the road information indicating the present position is not matched with the identification information of a road having a wide road width such as a national road or a prefectural road (when it is determined that the road width is narrow), the sound volume of the voice included in the advertisement information is set to a predetermined sound volume less than the threshold value (Step S1103). The advertisement process part 213 transmits the information of the determined sound volume to the display device 22 (Step S1104). The advertisement information output part 222 of the display device 22 changes the output sound volume of the voice to the sound volume received from the deliverer terminal 21 and outputs the advertisement information (voice) (Step S1105). Thereby, the voice of the advertisement information can be output at a high sound volume during moving on a road having a wide road width, and the voice of the advertisement information can be output at a low sound volume during moving in a residential area where there are many roads and streets having a relatively narrow width. The process of determining the sound volume in the process of the eighth embodiment may be similarly performed by the display device 22. Processes similar to the processes of Step S1101 to Step S1104 may be performed by the display device 22.

### Tenth Embodiment

The display device 22 of the display system 1 may display code information such as a two-dimensional code relating to the advertisement information on the display. For example, the advertisement information further includes code information that includes information of a shop name of the shop of the delivery origin of the delivery object, a telephone number, the URL of the web page, and the like. The advertisement information output part 222 of the display device 22 displays the code information included in the advertisement information on the display. Thereby, a passerby in the vicinity of the deliverer can acquire the information of the delivery source of the delivery object that is output in the advertisement information by confirming the video or voice of the advertisement information and then reading the code information through a mobile terminal.

### Eleventh Embodiment

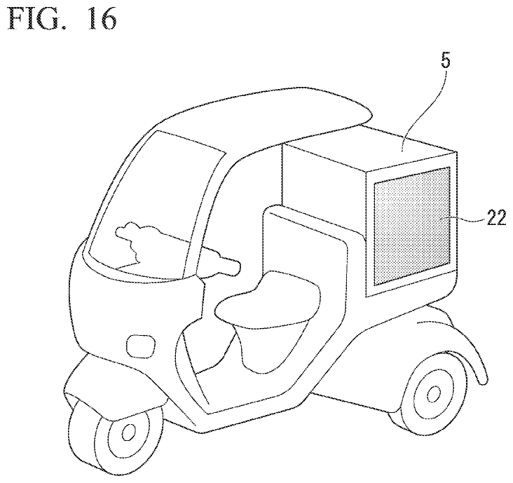

FIG. 16 is a view showing a form of a display device 22 according to an eleventh embodiment.

The above embodiments are described using an example in which the display device 22 is attached to the carry bag 3 that stores the delivery object. However, the display device 22 may be attached to a storage part such as a box which stores the delivery object and is provided on the vehicle. As an example, FIG. 16 shows an example in which the display device 22 is attached to a storage box 5 (a storage box) provided on a rear part of a three-wheel vehicle, which is an aspect of the vehicle. The display device 22 may be attached to a body of a four-wheel vehicle by an attachment tool. The display system shown in FIG. 16 is also an embodiment in which the display surface (display) of the display part (display device 22) is attached to the storage part (storage box 5) on an outer portion of the storage part (storage part box 5) so as to face outward.

Although the embodiments of the present invention have been described, the present invention is not limited to such embodiments, and various modifications and substitutions can be made without departing from the scope of the present invention.

What is claimed is:

1. A display system, comprising:
a portable terminal;
a storage part that stores a delivery object; and
a display part that is capable of communicating with the portable terminal and displays an advertisement image based on information acquired from the portable terminal,
wherein a display surface of the display part is attached to the storage part on an outer portion of the storage part so as to face outward.

2. The display system according to claim 1,
wherein the advertisement image is an image relating to the delivery object.

3. The display system according to claim 1,
wherein the advertisement image is an image relating to a shop that prepares the delivery object.

4. The display system according to claim 1,
wherein the display part displays the advertisement image during delivery of the delivery object.

5. The display system according to claim 1,
wherein the display part displays the advertisement image in a case where the display part is within a deliverable area of the delivery object.

6. The display system according to claim 1,
wherein the display part stops displaying of the advertisement image when a distance between the display part and a delivery destination of the delivery object is equal to or less than a predetermined distance.

7. The display system according to claim 1,
wherein a state in which the display part displays the advertisement image and a state in which the display part does not display the advertisement image are switchable by an operation of the portable terminal.

8. The display system according to claim 1,
wherein a state in which the display part displays the advertisement image and a state in which the display part does not display the advertisement image are switchable based on information received from an external device.

9. The display system according to claim 2,
wherein a display time of the advertisement image in the display part is measured.

10. The display system according to claim 2,
wherein output information relating to the advertisement image displayed on the display part is output based on acquired position information of the display part.

11. The display system according to claim 10,
wherein an output form of the output information relating to the advertisement image displayed on the display part is changed based on the position information.

12. The display system according to claim 2,
wherein the display part displays code information relating to content that is advertised by the advertisement image.

13. The display system according to claim 1,
wherein the storage part is a bag that stores the delivery object.

14. The display system according to claim 1,
wherein the storage part is attached to a vehicle and stores the delivery object.
